(19) United States
(12) Patent Application Publication
(10) Pub. No.: US 2014/0313703 A1
(43) Pub. Date: Oct. 23, 2014

(54) LED LIGHTING MODULE HAVING BATTERY POWER AND PHOTOVOLTAIC CHARGING

(71) Applicant: Spring Grove Trading Company LLC, Perrysburg, OH (US)

(72) Inventors: Keith E. GUENTHER, Milan, MI (US); Michael J. CICAK, Perrysburg, OH (US)

(73) Assignee: Spring Grove Trading Company LLC, Perrysburg, OH (US)

(21) Appl. No.: 14/225,973

(22) Filed: Mar. 26, 2014

Related U.S. Application Data
(60) Provisional application No. 61/805,550, filed on Mar. 27, 2013.

(51) Int. Cl. F21S 9/03; F21S 8/08; F21K 99/00

(52) U.S. Cl. CPC F21S 9/037; F21K 9/10; F21S 8/08
USPC 362/183

(57) ABSTRACT

A lighting module (10) having a bank (28) of LEDs powered by a lithium ion battery bank (24) under the operation of a control regulator (26) with the battery bank powered by a photovoltaic panel (16).

### CROSS-REFERENCE TO RELATED APPLICATIONS

This application claims the benefit of U.S. provisional application Ser. No. 61/805,550 filed Mar. 27, 2013, the disclosure of which is hereby incorporated in its entirety by reference herein.

### TECHNICAL FIELD

The invention involves a battery powered light emitting diode (LED) lighting module having photovoltaic charging.

### BACKGROUND

Lighting modules have previously been provided by remote sources which are normally supplied by alternating current.

### SUMMARY

The present invention provides a lighting module including: a frame; a photovoltaic panel mounted by the frame; an encapsulation material that enclosed semiconductor material of the photovoltaic panel; a control regulator; a lithium ion battery bank mounted on the frame and charged by the photovoltaic panel under the control of the control regulator; and a bank of light emitting diodes supported by the frame and powered by the lithium ion battery bank to provide light.

### BRIEF DESCRIPTION OF THE DRAWINGS

FIG. 1 is a view showing a battery powered LED lighting module constructed according to the invention to provide indoor and outdoor lighting.

FIG. 2 is an exploded cross-sectional view showing the lighting module which has multiple components as is hereinafter more fully described.

FIG. 3 is a cross-sectional view of the module 10 after assembly.

FIG. 4 is a schematic view showing the connection of the components for use.

FIG. 5 is a perspective view showing one component of the lighting module as an embodiment of a lithium ion battery bank which has a rectangular shape.

FIG. 6 is a perspective view of another embodiment of the lithium ion battery bank which has a square shape.

FIG. 7 is a view showing a prior art lighting pole with a photovoltaic panel and a separate LED lighting panel.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

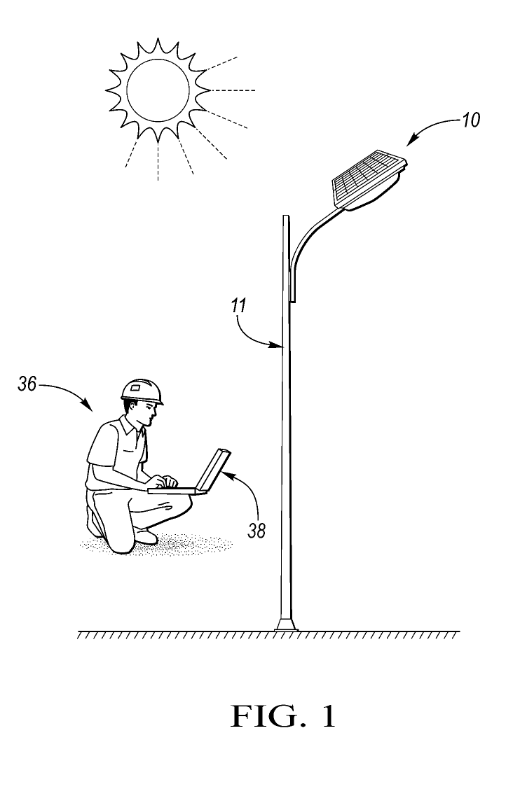

With reference to FIG. 1, a LED lighting module generally indicated by 10 is used indoors and outdoors to provide directed light and is battery powered with photovoltaic charging. The module can be used for parking lot lights, street lights, off-grid and remote lighting and power needs, etc. and is powered by sunlight during the day to provide lighting as needed by user. As shown, for parking lots and street light applications, a pole structure 11 supports the module 10 on the ground and can be operated by a remote computer control.

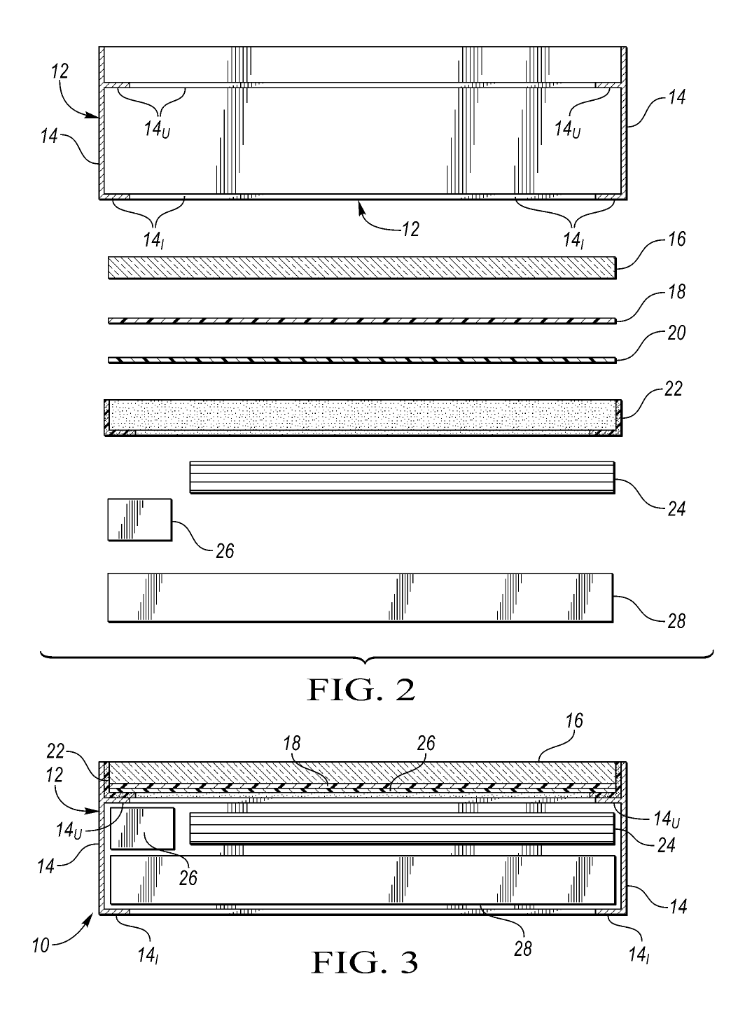

The module 10 has a frame 12 of a rectangular shape in a plan direction, and the frame as shown in FIGS. 2 and 3 includes any mechanical enclosure such as the illustrated extruded aluminum channels 14 defining the sides and ends of its rectangular shape. The channels 14 each include an upper flange 14ᵤ and a lower flange 14ₗ that function in the assembled module as described below.

A photovoltaic panel 16 of the module 10 is made of semiconductor material and is supported within the frame 12 by the upper flanges 14ᵤ of the assembled channels 14 and receives sunlight for generation of electrical power. The photovoltaic panel 16 has an encapsulation material 18 that encloses its semiconductor and connector layers, a back protective sheet 20 that provides protection, and an adhesive gasket 22 that provides its mounting within the channels 14 on their upper flanges 14ᵤ. The photovoltaic panel 16 may include a glass sheet on which the semiconductor material, preferably cadmium telluride and cadmium sulfide, is deposited and separated into cells connected in series with each other with a construction such as disclosed by U.S. Pat. No. 5,248,349 Foote et al., the entire disclosure of which is hereby incorporated by reference.

Below the photovoltaic panel 16, the module 10 includes a lithium ion battery bank 24 charged by the photovoltaic panel 16, and the module also includes a control regulator 26. A bank 28 of light emitting diodes (LED) of the module is supported by the lower flanges 14ₗ of the channels 14 below the lithium ion battery bank 24 and below the control regulator 26 and is powered by the lithium ion battery bank under the control of the control regulator to provide downwardly directed light.

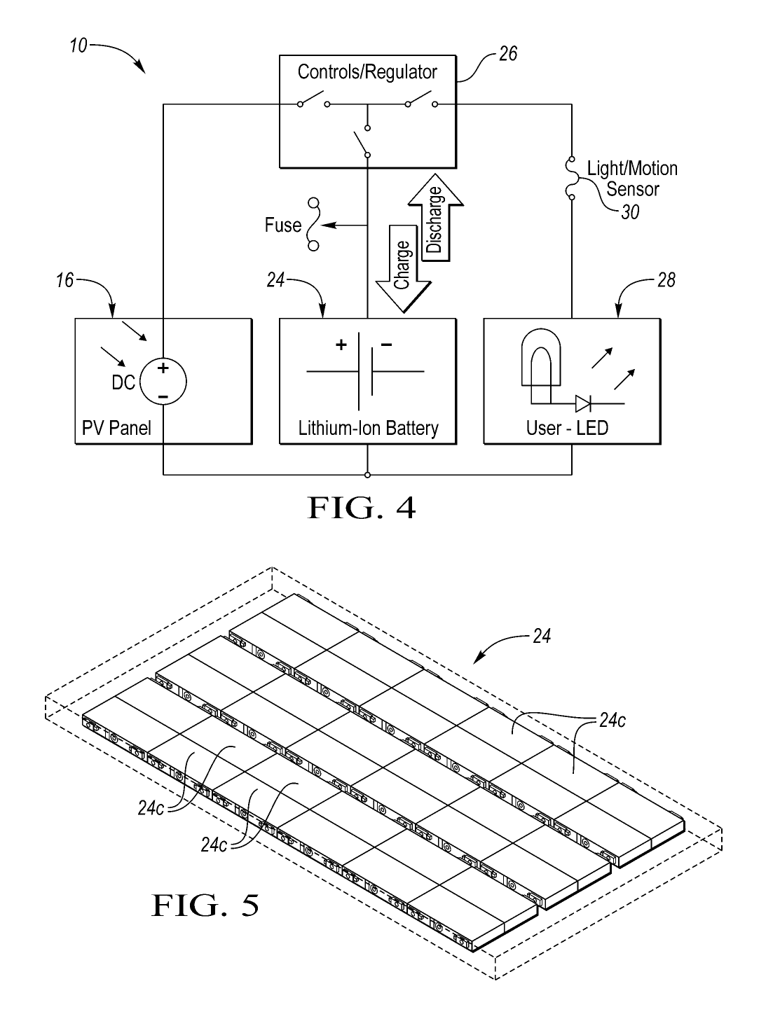

The control regulator 26 may be provided with sensing and control circuitry to provide the LED lighting only when dark outside or only when it is dark and motion is sensed by a sensor 30 as shown in FIG. 4.

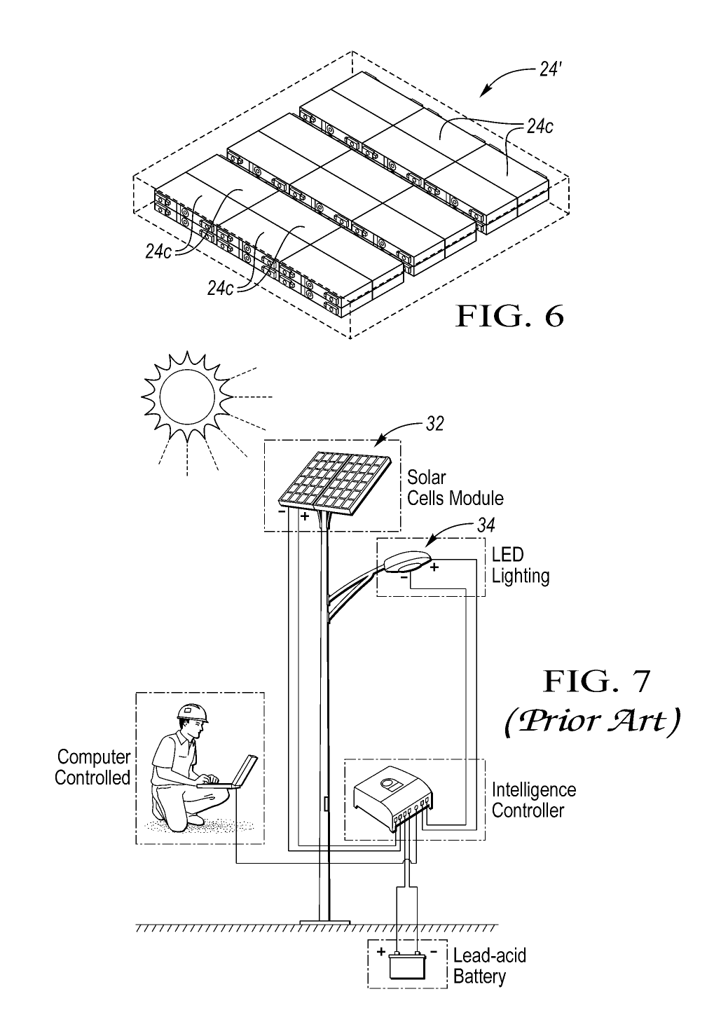

The lithium ion battery bank 28 may have different sizes such as shown in FIG. 4 with a 120 centimeter length, a 60 centimeter width, and a 4.5 centimeter thickness. Also, the module may have a square shape with the lithium ion battery bank 24′ shown in FIG. 6, which is 60 centimeters both long and wide and also of a 4.5 centimeter thickness. Each of these battery banks 24 and 24′ is divided into cells 24_{c} that are connected in series with each other to provide the overall battery voltage.

The module advantageously will include a battery management system which will monitor the voltage of each battery cell, monitor the voltage of the entire battery whose cells are connected in series, monitor the temperature of groups of cells such as 6 as well as the temperature of the battery as a whole to determine whether there is overheating so that a shutoff switch can operate to prevent battery damage, and monitor the battery current and perform higher level functions such as battery state determination.

Compared to the prior art such as shown in FIG. 7 where a photovoltaic module 32 is separate from an LED lighting module 34, the integrated module of the photovoltaic panel 16, lithium ion battery bank 24 or 24′, the control regulator 26, and the bank 28 of LED's as well as the light/motion sensor 30 facilitate the installation and use of the lighting module as shown in FIG. 1 which shows an operator 36 using a computer 38 with a wireless connection to operate the control regulator.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A lighting module comprising:
a frame;
a photovoltaic panel mounted by the frame and having semiconductor material that receives sunlight to generate electrical power;
the photovoltaic panel having an encapsulation material that enclosed the semiconductor material;
a control regulator;
a lithium ion battery bank that is mounted by the frame and charged by the photovoltaic panel under the control of the control regulator; and
a bank of light emitting diodes supported by the frame and powered by the lithium ion battery bank to provide light.

2. A light emitting module as in claim 1 further including a pole structure for providing ground support.
